(19) United States
(12) Patent Application Publication
(10) Pub. No.: US 2024/0400304 A1
(43) Pub. Date: Dec. 5, 2024

(54) LOCKOUT DEVICE FOR A CARRIAGE LIFT ASSEMBLY

(71) Applicant: Intelligrated Headquarters, LLC, Mason, OH (US)

(72) Inventor: Benjamin P. Hart, Cincinnati, OH (US)

(21) Appl. No.: 18/328,349

(22) Filed: Jun. 2, 2023

(51) Int. Cl. B65G 1/04; B66F 17/00

(52) U.S. Cl. CPC B65G 1/0492; B66F 17/00

(57) ABSTRACT

In various aspects, a carriage lift assembly for an automated storage and retrieval system is provided. The carriage lift assembly can include a mast member, a carriage, and a lockout device. The lockout device can include a moveable member that is configured to move from a first position to a second position. When the moveable member of the lockout device is in the first position, at least a portion of the moveable member can be at a location that is vertically between two wheels of the carriage. When the moveable member of the lockout device is in the second position, the moveable member can be positioned away from the location that is vertically between the two wheels of the carriage.

### TECHNICAL FIELD

The present application relates generally to material handling systems, and, more particularly, to a lockout device for carriage lift assemblies of material handling systems.

### BACKGROUND

Automated Storage and Retrieval Systems (ASRS), such as ASRS product lifts, are used as material handling systems to facilitate movement of high volumes of articles and maximize the use of valuable storage space. ASRSs are key components in material handling environments by combining automation, software, and labor to optimize the productivity and throughput in a variety of operations. Furthermore, ASRSs provide flexibility and speed allowing use in applications ranging from e-commerce and omnichannel fulfillment to article distribution. The inventors have identified numerous deficiencies and problems with the existing technologies in this field. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include apparatuses to provide for improved safety of a carriage lift assembly for an automated storage and retrieval system. The carriage lift assembly can include a lockout device that prevents movement of one or more moveable components of the carriage lift assembly, which may increase the safety of the carriage lift assembly.

In various aspects, a carriage lift assembly for an automated storage and retrieval system is provided. The carriage lift assembly can define a horizontal direction and a vertical direction. The carriage lift assembly can include a mast member and a carriage that has a plurality of wheels that are positioned on the mast member. The carriage can be configured to move along the mast member. The carriage lift assembly can include a lockout device that is removably coupled to the mast member. The lockout device can include a moveable member that is configured to move from a first position to a second position. When the moveable member of the lockout device is in the first position, at least a portion of the moveable member can be at a location that is vertically between at least two of the plurality of wheels of the carriage. When the moveable member of the lockout device is in the second position, the moveable member can be positioned away from the location that is vertically between the at least two of the plurality of wheels of the carriage.

In various examples, the lockout device comprises a plate. At least a portion of the plate can have a dovetail shape.

In various examples, the mast member includes a slot. A shape of the slot of the mast member can correspond to the dovetail shape of the plate of the lockout device.

In various examples, the dovetail shape of the plate extends a complete length of the plate. The plate of the lockout device can be configured to slide along the slot of the mast member.

In various examples, the mast member includes a slot that extends in the vertical direction and the lockout device includes a plate that extends in the vertical direction. The plate of the lockout device can be positioned within the slot of the mast member.

In various examples, the moveable member includes two horizontal portions that are connected by a vertical portion. The vertical portion can have a length of at least three inches and up to eight inches.

In various examples, the moveable member is configured to translate from the first position to the second position.

In various examples, when the moveable member is in the first position, the carriage is prevented from moving past the lockout device. When the moveable member is in the second position, the carriage may be allowed to move past the lockout device.

In various examples, the lockout device is removably coupled to the mast member with at least one fastener.

In various aspects, a lockout device for a carriage lift assembly for an automated storage and retrieval system is provided. The lockout device can be configured to be removably coupled to a mast member of the carriage lift assembly. The lockout device can include a moveable member that is configured to move from a first position to a second position. When the moveable member is in the first position, the moveable member of the lockout device can be configured to have at least a portion of the moveable member at a location that is vertically between at least two wheels of a carriage of the carriage lift assembly. When the moveable member is in the second position, the moveable member of the lockout device can be configured to be positioned away from the location that is vertically between the at least two wheels of the carriage of the carriage lift assembly.

In various examples, the lockout device comprises a plate. At least a portion of the plate can have a dovetail shape.

In various examples, the mast member includes a slot. A shape of the slot of the mast member can correspond to the dovetail shape of the plate of the lockout device.

In various examples, the dovetail shape of the plate extends a complete length of the plate. The plate of the lockout device can be configured to slide along the slot of the mast member.

In various examples, the mast member includes a slot that extends in the vertical direction and the lockout device includes a plate that extends in the vertical direction. The plate of the lockout device can be positioned within the slot of the mast member.

In various examples, the moveable member includes two horizontal portions that are connected by a vertical portion. The vertical portion can have a length of at least three inches and up to eight inches.

In various examples, the moveable member is configured to translate from the first position to the second position.

In various examples, when the moveable member is in the first position, the carriage is prevented from moving past the lockout device. When the moveable member is in the second position, the carriage may be allowed to move past the lockout device.

In various examples, the lockout device is removably coupled to the mast member with at least one fastener.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure are described with reference to the following figures, which are not necessarily drawn to scale and wherein like reference numerals refer to like parts throughout the various views unless otherwise specified. The components illustrated in the figures may or may not be present in certain embodiments described herein. Some embodiments may include fewer (or more) components than those shown in the figures.

FIG. 1 provides a perspective view of a carriage lift assembly, in accordance with an example embodiment.

FIG. 2 provides a perspective view of the carriage lift assembly of FIG. 1, in accordance with an example embodiment.

FIG. 3 provides a perspective, front view of a lockout device of the carriage lift assembly of FIG. 1, in accordance with an example embodiment.

FIG. 4 provides a perspective, back view of the lockout device of FIG. 3, in accordance with an example embodiment.

FIG. 5 provides a close-up, perspective, back view of the lockout device of FIG. 3, in accordance with an example embodiment.

### DETAILED DESCRIPTION

One or more embodiments are now more fully described with reference to the accompanying drawings, wherein like reference numerals are used to refer to like elements throughout and in which some, but not all embodiments of the inventions are shown. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements.

As used herein, the term “exemplary” means serving as an example, instance, or illustration. Any aspect or design described herein as “exemplary” is not necessarily to be construed as preferred or advantageous over other aspects or designs. Rather, use of the word exemplary is intended to present concepts in a concrete fashion. In addition, while a particular feature may be disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the term “positioned directly on” refers to a first component being positioned on a second component such that they make contact. Similarly, as used herein, the term “positioned directly between” refers to a first component being positioned between a second component and a third component such that the first component makes contact with both the second component and the third component. In contrast, a first component that is “positioned between” a second component and a third component may or may not have contact with the second component and the third component. Additionally, a first component that is “positioned between” a second component and a third component is positioned such that there may be other intervening components between the second component and the third component other than the first component.

As used herein, terms of approximation, such as “approximately,” “substantially,” or “about,” refer to being within manufacturing or engineering tolerances. For example, terms of approximation may refer to being within a five percent margin of error.

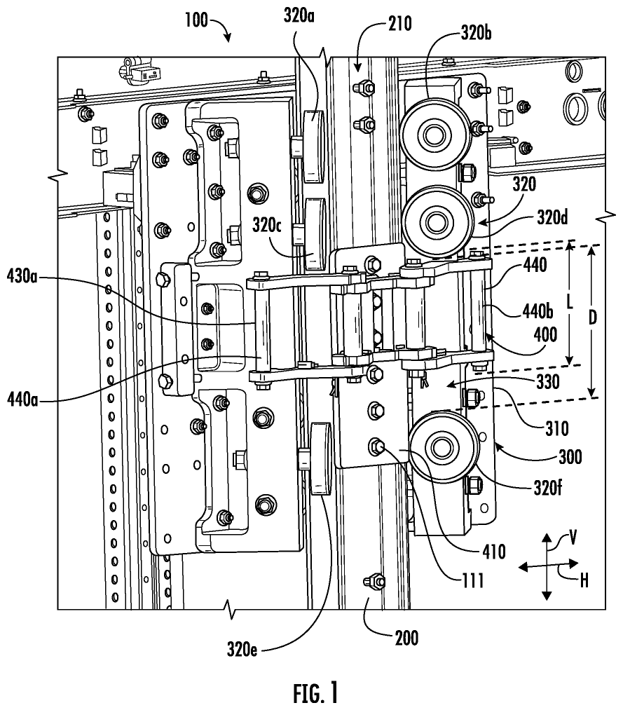

Referring now to FIG. 1, a perspective view of a carriage lift assembly 100 is provided, in accordance with an example embodiment. The carriage lift assembly 100 can define a vertical direction V and a horizontal direction H that is orthogonal to the vertical direction V. The carriage lift assembly 100 can also define a transverse direction T (substantially in and out of page) that is orthogonal to the vertical direction V and the horizontal direction H.

The carriage lift assembly 100 can include a mast member 200 and a carriage 300. The mast member 200 can extend substantially in the vertical direction V and the carriage 300 can be configured to move relative to the mast member 200 in the vertical direction V. For example, the carriage 300 can have a main body 310 and a plurality of wheels 320 that are coupled to the main body 310. Each of the plurality of wheels 320 can be positioned on the mast member 200 and can be configured to roll along the mast member 200 in the vertical direction V. The carriage lift assembly 100, mast member 200, and carriage 300 can be configured similarly to, or the same as, the carriage lift assembly 100, the mast member 102, and the carriage assembly 120 of U.S. patent application Ser. No. 16/119,266, filed Aug. 31, 2018, which is hereby incorporated by reference in its entirety.

In various examples, and as depicted in FIG. 1, the carriage 300 has six wheels 320a-f. However, in various other examples, the carriage 300 has less than or more than six wheels 320. For example, the carriage 300 can include four, eight, or ten wheels 320. The plurality of wheels 320 can define pairs of wheels 320, each wheel 320 of the pairs of wheels 320 can be positioned on opposite sides of the mast member 200. For example, wheels 320a, 320c, and 320e can be paired with and positioned on the opposite side of the mast member 200 as wheels 320b, 320d, 320f, respectively. Each wheel 320 within a pair of wheels 320 can be positioned approximately at the same vertical position, but on opposite sides of the mast member 200, as depicted in FIG. 1. However, in various other examples, the wheels 320 can be staggered such that at least one of the plurality of wheels 320 is not at the same vertical position as another one of the plurality of wheels 320.

The carriage lift assembly 100 can include a lockout device 400. The lockout device 400 can be configured to be removably coupled to the mast member 200. For example, one or more fasteners 111, such as one or more bolts, screws, or rivets, can be used to couple the lockout device 400 to the mast member 200. Each of the one or more fasteners 111 can be removed to decouple the lockout device 400 from the mast member 200. As will be discussed in more detail, the lockout device 400 can be removably coupled to the mast member 200 and, in some instances, be configured to allow the plurality of wheels 320 of the carriage 300 to move past the lockout device 400, which allows movement of the carriage 300 past the lockout device 400, and, in other instances, be configured to prevent the plurality of wheels 320 of the carriage 300 from moving past the lockout device 400, which may prevent the carriage 300 from moving past the lockout device 400.

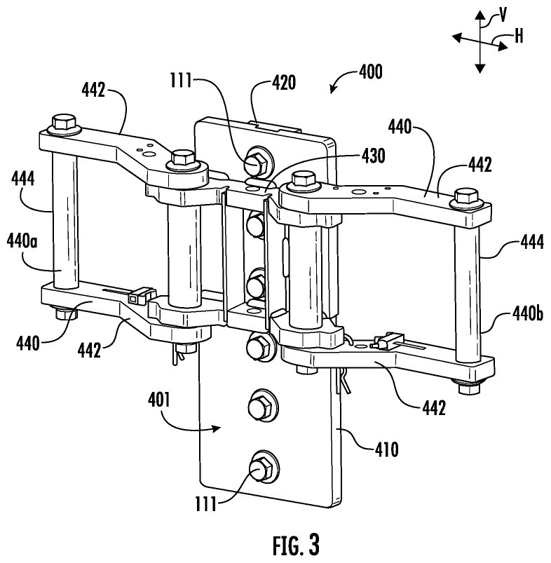

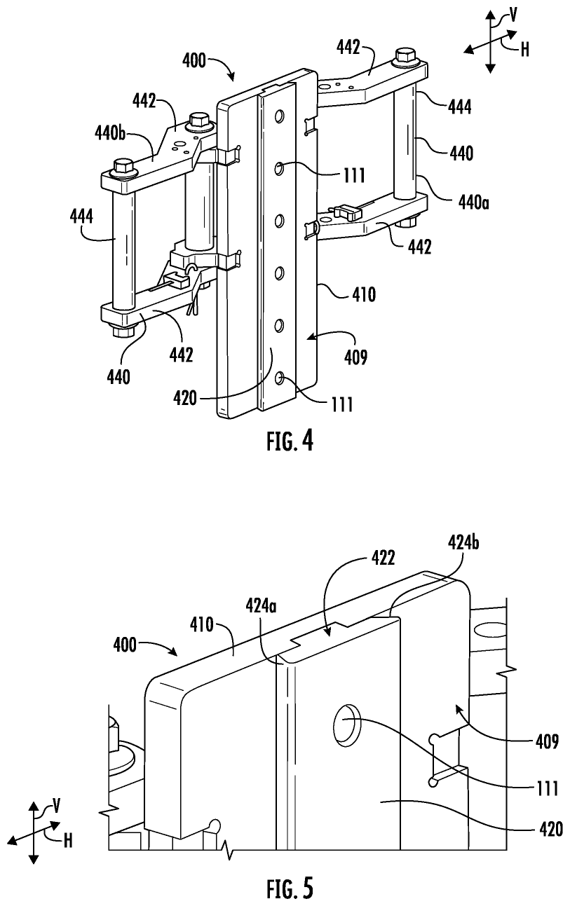

Referring now to FIGS. 3-5, perspective views of the lockout device 400 of the carriage lift assembly 100 of FIG. 1 are provided, in accordance with an example embodiment. More specifically, FIG. 3 provides a front view of the lockout device 400, FIG. 4 provides a back view of the lockout device 400, and FIG. 5 provides a close-up, back view of the lockout device 400.

The lockout device 400 can define a front side 401 (FIG. 3) and a backside 409 (FIG. 4). The lockout device 400 can include a main body 410. The main body 410 can generally have a cuboid shape. The main body 410 can have one or more orifices that each allow a fastener 111 to extend through.

The lockout device 400 can include a plate 420 that is positioned on the backside 409 of the lockout device 400. As depicted, the plate 420 can be a separate component as the main body 410. However, in various examples, the plate 420 can be integral with the main body 410. The plate 420 can extend generally in the vertical direction V. The plate 420 can have one or more orifices that each allow a fastener 111 to extend through. In various examples, each of the one or more fasteners 111 can extend through an orifice of the main body 410 and an orifice of the plate 420 to couple the lockout device 400 to the mast member 200 of the carriage lift assembly 100.

Referring to FIG. 5, the plate 420 of the lockout device 400 can have a cross-sectional shape that is generally T-shaped. In various examples, and as depicted in FIG. 5, the plate 420 can have at least a portion 422 that is dovetail shaped. For example, the portion 422 that is dovetail shaped can be isosceles trapezium shaped such that at least two sides, such as side 424a and side 424b, have approximately the same length and are non-parallel. The portion 422 that is dovetail shaped can be a sliding dovetail such that the dovetail shape extends a complete length of the plate 420.

Referring back briefly to FIG. 1, the shape of the portion 422 of the plate 420 of the lockout device 400 can correspond to a shape of a slot 210 of the mast member 200. For example, when the portion 422 of the plate 420 has a dovetail shape, the slot 210 of the mast member 200 may also have a dovetail shape. When the dovetail shape extends the whole length of the plate 420, the plate 420 and/or the lockout device 400 can be assembled with the mast member 200 by sliding the portion 422 of the plate 420 of the lockout device 400 into the slot 210 of the mast member 200. Once the portion 422 of the plate 420 is positioned within the slot 210 of the mast member 200, the plate 420 can be moved along the mast member 200 to a final position. The main body 410 of the lockout device 400 may then be installed on the plate 420 by the use of one or more fasteners 111, which may also extend at least partially through the mast member 200, which may maintain the position of the lockout device 400 relative to the mast member 200.

Referring back to FIGS. 3-5, the lockout device 400 can include at least one moveable member 440. For example, and as depicted, the lockout device 400 can include two moveable members 440, a first moveable member 440a and a second moveable member 440b. Each of the first moveable member 440a and the second moveable member 440b can be configured substantially similar except that they are positioned such that they are mirror images of each other. Each moveable member 440 can be coupled to the main body 410 of the lockout device 400 either directly or indirectly. For example, each moveable member 440 can be indirectly coupled to the main body 410 through one or more intervening components, such as support 430, which can be directly coupled to the main body 410.

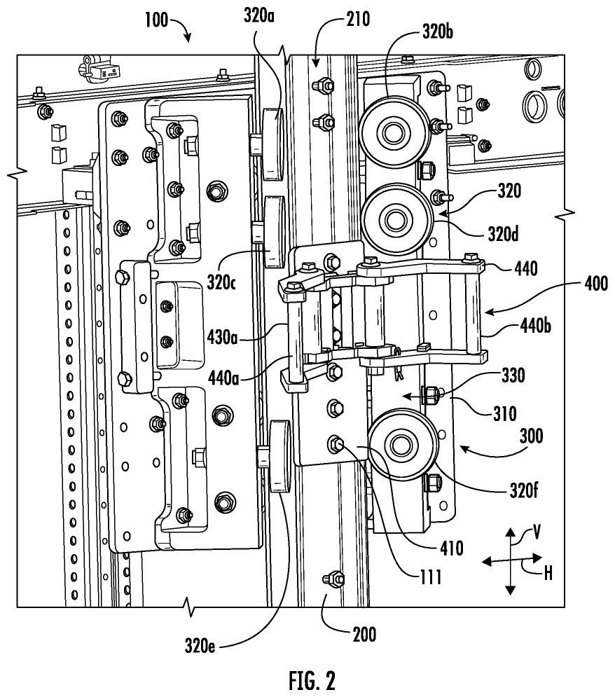

Each moveable member 440 can be configured to move from a first position, as depicted in FIG. 1, to a second position, as depicted in FIG. 2. In various examples, and as depicted in FIGS. 1 and 2, the moveable member 440 may be configured to pivot from the first position to the second position. Alternatively or additionally, the moveable member 440 may be configured to translate from the first position to the second position.

Each moveable member 440 can be have two horizontal portions 442 that extend generally in the horizontal direction H that are connected by a vertical portion 444 that extends generally in the vertical direction V. The vertical portion 444 may be sized to allow a hand of a user to grip the vertical portion 444 (e.g., a length of at least 3 inches, such as at least 4 inches, such as at least 3 inches and up to 8 inches, such as at least 4 inches and up to 7 inches).

Referring back to FIGS. 1-2, each moveable member 440 of the lockout device 400 can be configured to move from a first position, as depicted in FIG. 1, to a second position, as depicted in FIG. 2. A user may move the moveable member 440 of the lockout device 400 from the first position to the second position. Alternatively or additionally, the moveable member 440 may be moved from the first position to the second position by a rotary actuator (not depicted).

In various examples, at least one space 330 may be defined between two of the plurality of wheels 320 (e.g., between wheel 320d and wheel 320f and/or between when 320c and when 320e). The space 330 between the two of the plurality of wheels 320 may define a distance D between the two of the plurality of wheels 320. The distance D may be greater than a vertical length L of the at least one moveable members 440 of the lockout device 400. As such, when the moveable member 440 of the lockout device 400 is in the first position, as depicted in FIG. 1, at least a portion of the at least one moveable member 440 of the lockout device 400 can be at a location that is vertically between at least two of the plurality of wheels 320. For example, and as depicted, at least a portion of the first moveable member 440a can be positioned vertically between wheel 320c and wheel 320e when the first moveable member 440a is in the first position and/or at least a portion of the second moveable member 440b can be positioned vertically between wheel 320d and wheel 320f when the second moveable member 440b is in the first position.

When the at least one moveable member 440 of the lockout device 400 is in the second position, each of the at least one moveable member 440 (e.g., the entirety of the at least one moveable member 440) is positioned away from the location that is vertically between the at least two of the plurality of wheels 320. Stated differently, when the at least one moveable member 440 of the lockout device 400 is in the second position, each of the at least one moveable member 440 is not at the location that is vertically between the at least two of the plurality of wheels 320.

As will be appreciated, when the at least one moveable member 440 of the lockout device 400 is in the first position, as depicted in FIG. 1, the portion of the moveable member 440 that is positioned at the location that is vertically between at least two of the plurality of wheels 320 may prevent a vertical movement of the wheels 320 past the moveable member 440. For example, when the first moveable member 440a is in the first position, the first moveable member 440a may prevent the wheel 320c from moving downward in the vertical direction past the first moveable member 440a and may prevent the wheel 320e from moving upward in the vertical direction V past the first moveable member 440a. Similarly, when the second moveable member 440b is in the first position, the second moveable member 440b may prevent the wheel 320d from moving downward in the vertical direction past the second moveable member 440b and may prevent the wheel 320f from moving upward in the vertical direction V past the second moveable member 440b. As will be appreciated, preventing at least one of the plurality of wheels 320 of the carriage 300 from moving past the moveable member 440 may also prevent the carriage 300 from moving past the moveable member 440.

In contrast, when the at least one moveable member 440 of the lockout device 400 is in the second position, as depicted in FIG. 2, each moveable member 440 allows a movement (e.g., does not prevent a movement) of the wheels 320 past the moveable member 440. As will be appreciated, allowing all of the plurality of wheels 320 of a carriage 300 to move past the moveable member 440 may also allow the carriage 300 to move past the moveable member 440 of the lockout device 400.

Providing a carriage lift assembly 100 that includes a lockout device 400, as described herein, may increase the safety of the carriage lift assembly 100, which may be beneficial. For example, it may be necessary for an individual to be near the carriage lift assembly 100 to, for example, perform maintenance on the carriage lift assembly 100 or components thereof. As such, preventing the moveable components of the carriage lift assembly 100 from moving, such as the carriage 300, may be desirable to prevent injury to the individual that is near the carriage lift assembly 100. The lockout device 400 may prevent the carriage 300 from moving by moving the at least one moveable member 440 to the first position. As such, the lockout device 400 increases the safety of the carriage lift assembly 100 when the at least one moveable member 440 of the lockout device 400 is in the first position.

The lockout device 400 may be advantageous over other current devices to maintain the position of a carriage 300 of a carriage lift assembly 100 because it allows for the position of the carriage 300 to be maintained at any height. For example, and as previously discussed, the lockout device 400 may include a plate 420 that can slide within a slot 210 of the mast member 200. Therefore, the lockout device 400 can be positioned anywhere along the mast member 200 to position the lockout device 400 at the desired location.

Also, notably, the lockout device 400 of the present disclosure can be removed from the carriage lift assembly 100 and removably coupled to another carriage lift assembly. As such, the lockout device 400 of the present disclosure may have an increased variety of uses than existing technologies.

Additionally, the lockout device 400 of the present disclosure may be advantageous over existing technologies because it allows movement of the carriage 300 without uninstalling the lockout device 400 from the carriage lift assembly 100. For example, when it is desirable to allow movement of the carriage 300, each of the at least one moveable member 440 can be moved to the second position.

### CONCLUSION

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the appended claims below. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A carriage lift assembly for an automated storage and retrieval system, the carriage lift assembly defining a horizontal direction and a vertical direction, the carriage lift assembly comprising:
a mast member;
a carriage comprising a plurality of wheels that are positioned on the mast member, wherein the carriage is configured to move along the mast member; and
a lockout device that is removably coupled to the mast member, the lockout device comprising a moveable member that is configured to move from a first position to a second position,
wherein when the moveable member of the lockout device is in the first position, at least a portion of the moveable member is at a location that is vertically between at least two of the plurality of wheels of the carriage, and
wherein when the moveable member of the lockout device is in the second position, the moveable member is positioned away from the location that is vertically between the at least two of the plurality of wheels of the carriage.

2. The carriage lift assembly of claim 1, wherein the lockout device comprises a plate, wherein at least a portion of the plate has a dovetail shape.

3. The carriage lift assembly of claim 2, wherein the mast member comprises a slot, wherein a shape of the slot of the mast member corresponds to the dovetail shape of the plate of the lockout device.

4. The carriage lift assembly of claim 3, wherein the dovetail shape of the plate extends a complete length of the plate.

5. The carriage lift assembly of claim 4, wherein the plate of the lockout device is configured to slide along the slot of the mast member.

6. The carriage lift assembly of claim 1, wherein the mast member comprises a slot that extends in the vertical direction and the lockout device comprises a plate that extends in the vertical direction, and wherein the plate of the lockout device is positioned within the slot of the mast member.

7. The carriage lift assembly of claim 1, wherein the moveable member comprises two horizontal portions that are connected by a vertical portion, wherein the vertical portion has a length of at least three inches and up to eight inches.

8. The carriage lift assembly of claim 1, wherein the moveable member is configured to translate from the first position to the second position.

9. The carriage lift assembly of claim 1, wherein when the moveable member is in the first position, the carriage is prevented from moving past the lockout device, and wherein when the moveable member is in the second position, the carriage is allowed to move past the lockout device.

10. The carriage lift assembly of claim 1, wherein the lockout device is removably coupled to the mast member with at least one fastener.

11. A lockout device for a carriage lift assembly for an automated storage and retrieval system, the lockout device being configured to be removably coupled to a mast member of the carriage lift assembly, the lockout device comprising:
a moveable member that is configured to move from a first position to a second position,
wherein when the moveable member is in the first position, the moveable member of the lockout device is configured to have at least a portion of the moveable member at a location that is vertically between at least two wheels of a carriage of the carriage lift assembly, and
wherein when the moveable member is in the second position, the moveable member of the lockout device is configured to be positioned away from the location that is vertically between the at least two wheels of the carriage of the carriage lift assembly.

12. The lockout device of claim 1, wherein the lockout device comprises a plate, wherein at least a portion of the plate has a dovetail shape.

13. The lockout device of claim 12, wherein the mast member comprises a slot, wherein a shape of the slot of the mast member corresponds to the dovetail shape of the plate of the lockout device.

14. The lockout device of claim 13, wherein the dovetail shape of the plate extends a complete length of the plate.

15. The lockout device of claim 14, wherein the plate of the lockout device is configured to slide along the slot of the mast member.

16. The lockout device of claim 11, wherein the mast member comprises a slot that extends in a vertical direction and the lockout device comprises a plate that extends in the vertical direction, and wherein the plate of the lockout device is positioned within the slot of the mast member.

17. The lockout device of claim 11, wherein the moveable member comprises two horizontal portions that are connected by a vertical portion, wherein the vertical portion has a length of at least three inches and up to eight inches.

18. The lockout device of claim 11, wherein the moveable member is configured to translate from the first position to the second position.

19. The lockout device of claim 11, wherein when the moveable member is in the first position, the carriage is prevented from moving past the lockout device, and wherein when the moveable member is in the second position, the carriage is allowed to move past the lockout device.

20. The lockout device of claim 11, wherein the lockout device is removably coupled to the mast member with at least one fastener.
